(19) United States
(12) Patent Application Publication
(10) Pub. No.: US 2022/0403176 A1
(43) Pub. Date: Dec. 22, 2022

(54) MOLYBDENUM OXYCHLORIDE WITH IMPROVED BULK DENSITY

(71) Applicant: MATERION CORPORATION, Mayfield Heights, OH (US)

(72) Inventors: Brendan J. LIDDLE, Mayfield Heights, OH (US); Katharine S. GARDINIER, Mayfield Heights, OH (US); Timothy LANDVATTER, Mayfield Heights, OH (US)

(73) Assignee: MATERION CORPORATION, Mayfield Heights, OH (US)

(21) Appl. No.: 17/770,814

(22) PCT Filed: Oct. 20, 2020
(86) PCT No.: PCT/US2020/056424

§ 371 Date: Apr. 21, 2022

Related U.S. Application Data
(60) Provisional application No. 62/923,892, filed on Oct. 21, 2019.

(51) Int. Cl. C09C 1/00; C09C 3/10; C09C 3/04

(52) U.S. Cl. CPC C09C 1/0003; C09C 3/10; C09C 3/04; C01P 2004/50; C01P 2006/11; C01P 2002/60; C01P 2006/12; C01P 2004/60

(57) ABSTRACT

Molybdenum oxychloride consolidated masses, comprising molybdenum oxychloride and less than 10 wt % binder. The consolidated masses have a bulk density greater than 0.85 g/cc.

### CROSS-REFERENCE TO RELATED APPLICATION

This application claims priority to U.S. Provisional Patent Application No. 62/923,892, filed Oct. 21, 2019, the entirety of which is incorporated herein by reference.

### FIELD

The present disclosure relates to molybdenum oxychloride compositions and consolidated masses, e.g., pellets, made therefrom. In particular, the present disclosure relates to molybdenum oxychloride compositions comprising low amounts, if any, binder, which demonstrate improvements in bulk density.

### BACKGROUND

Conventional molybdenum oxychloride compositions are often employed, typically in powder form, in high temperature thin film sublimation processing chambers. Generally, these molybdenum oxychloride compositions are synthesized in the form of lower density (fluffy) powders, which typically have relatively large average crystal sizes, e.g., cross body measurements, and/or lower surface areas. In operation, the powders are heated until sublimation, at which point the deposition occurs.

Generally speaking, powders (and often a pelletizing binder) can be pressed into pellets, e.g., tablets. However, powders having relatively large average crystal sizes often create problems in pellet formation, perhaps due to reduced potential for crystal-to-crystal adhesion, which potentially lead to lower bulk density pellets. Importantly, lower density pellets by nature comprise less powder composition. In the case of molybdenum oxychloride pellets, lower density pellets may contain less molybdenum oxychloride. As such, the lower density pellets, optionally with some subsequent treatment, must be frequently reloaded in thin film sublimation processing chambers, which results in down time and reductions in overall process inefficiency.

In some cases, a binder may be added to improve adhesion of the crystals, thus promoting improved pellet formation. Unfortunately, the introduction of binders creates additional problems, e.g., reduction of overall pellet purity, which must be addressed by further processing, e.g., post-pelletizing purification or “burning out” of the binder, prior to use of the pellets in the proposed application. Importantly, the addition of binder may also contribute to reductions in bulk density of the pellets.

Further, conventional molybdenum oxychloride powders suffer from the problems of poor particle size uniformity and/or poor shape uniformity and/or uneven heat transfer throughout their bulk, which results in inconsistencies in deposition.

In addition, conventional molybdenum oxychloride powders have been found to have accompanying packaging and transportation difficulties due to the lower densities, e.g., the powder (or low density consolidated masses made therefrom) take up too much volume in relation to the actual amount of molybdenum oxychloride. Thus, the ability to effectively use the available packaging and shipping is ineffective and additional packaging and shipping means must be employed.

In view of the conventional molybdenum oxychloride technology, the need exists for improved molybdenum oxychloride consolidated masses that demonstrate improved physical characteristics, e.g., increased bulk density and improved size/shape uniformity and heat transfer, and for molybdenum oxychloride compositions (powders) for use in forming the consolidated masses, e.g., while reducing or eliminating the need for binders.

### SUMMARY

In some embodiments, the present disclosure relates to molybdenum oxychloride consolidated masses comprising (greater than 95 wt %) molybdenum oxychloride and (less than 10 wt %, e.g., less than 5 wt %, binder (ceramic binders, celluloses, or hydroxyalkyl celluloses, or mixtures thereof). The consolidated masses have a bulk density greater than 0.85 g/cc, e.g., greater than 1.4 g/cc. The molybdenum oxychloride may comprise crystals, and at least 90% of the crystals may have an average cross body dimension less than 5 mm and/or a surface area greater than 0.0005 cm²/g. The consolidated masses may have a relative density greater than 75% and/or a uniformity of heat transfer across the individual consolidated masses less than ±10%. The consolidated masses may have an average cross body dimension greater than 1 mm.

In some embodiments, the present disclosure relates to a molybdenum oxychloride composition comprising (greater than 95 wt %) molybdenum oxychloride and less than 10% binder. The molybdenum oxychloride composition has a bulk density greater than 0.75 g/cc and/or a tap density greater than 1 g/cc, as measured by ASTM B527-2006. The molybdenum oxychloride may comprise crystals, and at least 90% of the crystals may have an average cross body dimension less than 1 mm and/or a surface area greater than 0.0005 cm²/g.

In some embodiments, the present disclosure relates to a process for producing molybdenum oxychloride consolidated masses, comprising providing a molybdenum oxychloride composition having a bulk density greater than 0.75 g/cc and comprising: molybdenum oxychloride; and less than 10% binder; and pressing the molybdenum oxychloride composition to form the consolidated masses. The consolidated masses have a bulk density greater than 1.4 g/cc. In some cases, the pressing comprises filling the molybdenum oxychloride composition into a mold and pressurizing the molded molybdenum oxychloride composition to form the consolidated masses. The pressurizing may be performed at a pressure less than 1000 MPa. The providing may comprise: synthesizing an intermediate molybdenum oxychloride composition comprising: molybdenum oxychloride; and less than 10% binder, wherein the intermediate molybdenum oxychloride composition comprises crystals and has a bulk density less than 0.75 g/cc; and separating the intermediate molybdenum oxychloride composition to form the molybdenum oxychloride composition.

### DETAILED DESCRIPTION

As noted above, conventional molybdenum oxychloride powders have large average crystal sizes, e.g., cross body measurements (as compared to the disclosed powders), and/or lower surface areas and/or may comprise significant amounts of binder. As a result, the consolidated masses, e.g., pellets, made from said powders may have lower than desired bulk densities. The low bulk densities of the pellets require frequent charging/reloading of the high temperature semiconductor processing chambers in which they are employed (in some cases pellets are treated before use in the chambers). This results in down time and reductions in overall process inefficiency. Further, these powders/pellets suffer from the problems of poor particle size and/or shape uniformity and uneven heat transfer throughout the bulk, which results in inconsistencies in deposition. Also, conventional powders/pellets suffer from problems relating to packaging and transportation, e.g., the pellets take up too much volume in relation to the actual amount of molybdenum oxychloride. Thus, the ability to effectively use the available packaging and shipping is ineffective and additional packaging and shipping means must be employed.

The inventors have now found that particular molybdenum oxychloride powders having relatively small crystals can be effectively pressed into higher density consolidated masses, e.g., pellets. Consolidated masses is a broad term encompassing bodies resulting from being formed or shaped from the compositions, e.g., powders, disclosed herein. In some cases, the consolidated masses are in the form of pellets, tablets, spheres, discs, or pastilles, or combinations thereof. The use herein of the term “pellet” or “pelletizing” is not intended to limit scope of the consolidated masses or related processes/processing. For example a “pellet” may have a spherical shape and/or “pelletizing” may form spherically-shaped consolidated masses.

Traditionally, problems have arisen in pelletizing powders having larger crystals, e.g., poor crystal-to-crystal adhesion and low bulk density. Without being bound by theory, it is postulated that the larger crystal structure has less surface area (per unit volume), which decreases the opportunities for crystal-to-crystal adhesion, i.e., self-adhesion, to form the consolidated masses. In the case of molybdenum oxychloride, by using powders having relatively small crystals, surface area is improved, which allows for better crystal-to-crystal adhesion and, in turn, for more effective pelletization. In addition, the consolidated masses have been found to have surprisingly higher bulk density as well as higher purity. Beneficially, because of the increased, bulk density, the need to reload pellets in the semiconductor processing chambers is significantly lessened. As such, overall production efficiencies are greatly improved.

In some cases, the powders (and the resultant consolidated masses) require low amounts, if any, binders, which advantageously contributes further to the reduction or elimination of the purity- and density-related problems associated with the binders. Without being bound by theory, it is postulated that by using less, if any, low density components, e.g., binders, the overall bulk density of the consolidated masses is improved. Also, the need for further processing, e.g., post-pelletizing separation or “burning out” of the binder, prior to use of the consolidated masses in the semiconductor processing chambers is beneficially reduced or eliminated.

Also, it has been discovered that the higher density consolidated masses disclosed herein have more consistent uniformity and heat transfer across the consolidated mass, which, advantageously, provides for more uniform deposition in semiconductor applications.

Molybdenum oxychloride is a known compound, generally available as a yellow or orange solid. For example, molybdenum oxychloride may have the CAS number 13637-68-8. Molybdenum oxychloride has a theoretical density of 3.31 g/cm³, however conventional molybdenum oxychloride compositions, e.g., powders, do not achieve this density due to the structure of the powders. As noted, conventional molybdenum oxychloride compositions, e.g., powders or pellets, have much lower actual, bulk, and/or relative densities.

### Consolidated Masses

In some embodiments, the present disclosure relates to molybdenum oxychloride consolidated masses. The consolidated masses comprise specific molybdenum oxychloride (powder) and lower amounts, if any, binder. The consolidated masses have high bulk density, e.g., a bulk density greater than 1.4 g/cc. Bulk density is a well-known measurement. For example, bulk density may be measured by weighing the quantity of a material contained in a known volume and calculating the weight of the consolidated masses per volume, i.e., the bulk density. Another method of measuring bulk density is provided in ASTM B329-2006. The molybdenum oxychloride comprises molybdenum oxychloride crystals, and, in some embodiments, the crystals are relatively small. As noted above, the small crystal size surprisingly provides for increased surface area, which allows for better crystal-to-crystal adhesion in the consolidated masses, which contributes, at least in part, to the improvements in bulk density. The molybdenum oxychloride powder itself will be discussed in more detail below.

In some embodiments, the bulk density of the consolidated masses may be greater than 0.85 g/cc, e.g., greater than 0.9 g/cc, greater than 1.0 g/cc, greater than 1.2 g/cc, greater than 1.4 g/cc, greater than 1.5 g/cc, greater than 1.7 g/cc, greater than 2.0 g/cc, greater than 2.1 g/cc, greater than 2.2 g/cc, greater than 2.5 g/cc, greater than 2.7 g/cc, or greater than 3.0 g/cc. In terms of ranges, the bulk density of the consolidated masses may range from 0.85 g/cc to 3.1 g/cc, e.g., from 0.9 g/cc to 3.1 g/cc, from 1.0 g/cc to 3.1 g/cc, from 1.2 g/cc to 3.1 g/cc, from 1.4 g/cc to 3.1 g/cc, from 1.4 g/cc to 3.0 g/cc, from 1.4 g/cc to 2.2 g/cc, from 1.4 g/cc to 2.8 g/cc, from 1.5 g/cc to 2.8 g/cc, from 1.6 g/cc to 2.5 g/cc, from 1.4 g/cc to 2.0 g/cc, or from 1.6 g/cc to 2.0 g/cc.

The consolidated masses may also be characterized in term of relative density. For example, the relative density of the consolidated masses may be greater than 75%, e.g., greater than 80%, greater than 85%, greater than 86.5%, greater than 87%, greater than 88%, greater than 90%, greater than 92%, greater than 95%, greater than 97%, or greater than 99%. In terms of ranges, the relative density of the consolidated masses may range from 75% to 99.9%, e.g., from 85% to 99%, from 88% to 99%, from 90% to 98%, from 91% to 97%, or from 92% to 96%. In some cases, the relative density is a measurement of how much air or impurities are present in the pellet. The relative density may be calculated as a ratio of actual measured density to maximum theoretical density, e.g., 3.31 for molybdenum oxychloride. The inventors have found that the use of the disclosed powders provides for lower amounts of air/impurities, which has unexpectedly provided for improvements in density and conductivity.

In some embodiments, by using molybdenum oxychloride powders having relatively small crystals, higher density consolidated masses may be achieved, in many cases, without the use of binders.

In some embodiments, at least 90% of the molybdenum oxychloride crystals have an average cross body dimension less than 5 mm, e.g., less than 4 mm, less than 3 mm, less than 2 mm, less than 1 mm, less than 0.7 mm, less than 0.5 mm, less than 0.3 mm, less than 0.1 mm, or less than 0.05 mm. In terms of ranges, at least 90% of the crystals may have an average cross body dimension ranging from 0.01 mm to 5 mm, e.g., from 0.05 mm to 3 mm, from 0.05 mm to 2 mm, from 0.1 mm to 3 mm, from 0.1 mm to 2 mm, from 0.1 mm to 1 mm, from 0.3 mm to 3 mm, from 0.3 mm to 2 mm, or from 0.5 mm to 1.5 mm. In terms of lower limits, at least 90% of the molybdenum oxychloride crystals have an average cross body dimension greater than 0.01 mm, e.g., greater than 0.05 mm, greater than 0.1 mm, greater than 0.3 mm, greater than 0.5 mm, or greater than 0.7 mm.

The crystals of the consolidated masses, in some embodiments, may have high surface area. For example, the crystals may have a surface area greater than 0.0005 cm²/g, e.g., greater than 0.001 cm²/g, greater than 0.005 cm²/g, greater than 0.007 cm²/g, greater than 0.01 cm²/g, greater than 0.012 cm²/g, greater than 0.015 cm²/g, greater than 0.017 cm²/g, greater than 0.02 cm²/g, greater than 0.025 cm²/g, greater than 0.05 cm²/g, greater than 0.1 cm²/g, or greater than 0.25 cm²/g. In terms of ranges, the crystals may have a surface area ranging from 0.0005 cm²/g to 1.0 cm²/g, e.g., from 0.001 cm²/g to 0.5 cm²/g, from 0.005 cm²/g to 0.1 cm²/g, from 0.007 cm²/g to 0.1 cm²/g, from 0.01 cm²/g to 0.1 cm²/g, or from 0.012 cm²/g to 0.05 cm²/g.

In some cases, the molybdenum oxychloride consolidated masses are high purity pellets. For example, the consolidated masses may comprise greater than 95 wt % molybdenum oxychloride, e.g., greater than 96 wt %, greater than 97 wt %, greater than 98 wt %, greater than 99 wt %, or greater than 99.5 wt %. In terms of ranges, the consolidated masses may comprise from 80 wt % to 99.999 wt % molybdenum oxychloride, e.g., from 90 wt % to 99.999 wt %, from 95 wt % to 99.99 wt %, or from 97 wt % to 99 wt %. In terms of lower limits, the consolidated masses may comprise less than 99.99 wt % molybdenum oxychloride, e.g., less than 99.9 wt %, less than 99.5 wt %, less than 99.3 wt %, or less than 99 wt %. Surprisingly, the use of lower amounts, if any, binder, e.g., an impurity, in the consolidated masses advantageously contributes to purity improvements.

As noted above, the use of lower amounts, if any, binder provided for the aforementioned benefits. In some embodiments, the consolidated masses comprise less than 10 wt % binder, e.g., less than wt %, less than 5 wt %, less than 3 wt %, less than 1 wt %, less than 0.7 wt %, less than 0.5 wt %, or less than 0.1 wt %. In terms of ranges, the consolidated masses comprise from 0.1 wt % to 10 wt % binder, e.g., from 0.1 wt % to 8 wt %, from 0.5 wt % to 7 wt %, from 1 wt % to 6 wt %, or from 2 wt % to 5 wt %.

Pelletization binders are well known in the art. Exemplary binders include ceramic binders, celluloses, and hydroxyalkyl celluloses. An exemplary commercial product is Klucel™ hydroxypropylcellulose from Ashland Chemical.

It has been discovered that the use of the disclosed powders (optionally with little, if any, binder) unexpectedly provides for improvements in the uniformity of heat transfer across the individual consolidated masses. Without being bound by theory, it is believed that the higher density consolidated masses have less air and/or impurities disposed therein. As a result the overall conductivity and heat transfer properties of the consolidated masses are improved. In some embodiments, the consolidated masses have a uniformity of heat transfer across the individual consolidated masses less than ±10%, e.g., less than ±8%, less than ±5%, less than ±3%, less than ±1%, less than ±0.5%, or less than ±0.1%.

The size of the consolidated masses may vary widely. In some cases, the consolidated masses may have an average cross body dimension, e.g., a length, greater than 1 mm, e.g., greater than 3 mm, greater than 5 mm, greater than 7 mm, greater than 10 mm, greater than 12 mm, greater than 15 mm, greater than 17 mm, greater than 20 mm, greater than 24 mm, or greater than 30 mm.

### Powder

As noted above, the consolidated masses are formed from specific powders. In some embodiments, the molybdenum oxychloride powders (molybdenum oxychloride compositions) comprise molybdenum oxychloride and little, if any binder, e.g., less than 10% binder. The molybdenum oxychloride powder has a bulk density greater than 0.75 g/cc. The molybdenum oxychloride powder is pressed into the consolidated masses. Thus, many of the aforementioned compositional features, characteristics, and measurements of properties of the consolidated masses are applicable to the powder as well, e.g., the molybdenum oxychloride and binder concentration, crystal size, surface area, etc. However, in some cases, the powders may have lower density characteristics, e.g., the powders may be less dense than the pellets.

In some embodiments, the bulk density of the powder may be greater than 0.55 g/cc, e.g., greater than 0.65 g/cc, greater than 0.75 g/cc, greater than 0.8 g/cc, greater than 0.85 g/cc, greater than 0.9 g/cc, greater than 1.0 g/cc, greater than 1.2 g/cc, greater than 1.5 g/cc, greater than 2.0 g/cc, or greater than 2.5 g/cc. In terms of ranges, the bulk density of the powder may range from 0.55 g/cc to 3.31 g/cc, e.g., from 0.65 g/cc to 3.31 g/cc, from 0.70 g/cc to 3.31 g/cc, from 0.75 g/cc to 3.31 g/cc, from 0.77 g/cc to 3.0 g/cc, from 0.78 g/cc to 2.5 g/cc, from 0.77 g/cc to 2.0 g/cc, from 0.55 g/cc to 2.0 g/cc, from 0.7 g/cc to 1.8 g/cc, from 1.0 g/cc to 1.5 g/cc, from 1.2 g/cc to 1.3 g/cc

The powder may have a high tap density in some cases. For example, the tap density of the powder may be greater than 0.5 g/cc, e.g., greater than 0.6 g/cc, greater than 0.7 g/cc, greater than 0.8 g/cc, greater than 0.85 g/cc, greater than 0.9 g/cc, greater than 1.0 g/cc, greater than 1.2 g/cc, greater than 1.5 g/cc, or greater than 2.0 g/cc. In terms of ranges, the tap density of the powder may range from 0.5 g/cc to 3.5 g/cc, e.g., from 0.5 g/cc to 2.0 g/cc, from 0.6 g/cc to 1.8 g/cc, from 0.7 g/cc to 1.5 g/cc, from 0.8 g/cc to 1.3 g/cc, from 0.9 g/cc to 1.1 g/cc, or from 0.95 g/cc to 1.05 g/cc. Tap density may be measured via ASTM B527-2006.

In some cases the bulk density of the consolidated masses may be at least 5% greater than the bulk density of the powder, e.g., at least 10% greater, at least 25% greater, at least 50% greater, at least 75% greater, or at least 100% greater.

### Processes for Producing the Consolidated Masses

The disclosure also relates to process for producing the consolidated masses. The process comprises the steps of providing the molybdenum oxychloride powder and pressing the powder to form the consolidated masses. The consolidated masses have the characteristics discussed herein.

The pressing, in some cases, may comprise the steps of filling the powder into a mold and pressurizing the molded powder to form the consolidated masses. The inventors have found that the particular powders disclosed herein provide for processing benefits. For example, the powders more completely fill the mold, e.g., the powders leave lower amounts, if any, for air pockets and/or other impurities that may affect pellet composition, density, and/or conductivity. Without being bound by theory, it is postulated that the smaller crystal sized aid in this improved packing of the mold. As a result, the higher density, high performance consolidated masses are formed.

In some cases, the pressurization of the molded powder may be conducted at lower pressures than those used when conventional powders are employed. It is believed that the smaller crystals and higher surface area of the powder advantageously contributes to crystal-to crystal adhesion, which allows the consolidated masses to be formed under less pressure.

In some embodiments, the pressurization is performed at a pressure less than 1000 MPa, e.g., less than 800 MPa, less than 750 MPa, less than 700 MPa, less than 650 MPa, less than 600 MPa. In terms of ranges, the pressurization may be performed at a pressure ranging from 50 MPa to 1000 MPa, e.g., from 100 MPa to 1000 MPa, from 50 MPa to 500 MPa, from 50 MPa to 400 MPa, from 50 MPa to 300 MPa, from 75 MPa to 400 MPa, from 100 MPa to 300 MPa, from 100 MPa to 200 MPa, from 200 MPa to 900 MPa, from 300 MPa to 800 MPa, from 400 MPa to 700 MPa, or from 400 MPa to 650 MPa. Beneficially, lower pressures improve operating efficiencies and also contribute to improvements on wear-and-tear of the equipment.

In other embodiments, the provision of the powder comprises the step of synthesizing an intermediate molybdenum oxychloride composition (powder) comprising molybdenum oxychloride and less than 10% binder. The intermediate molybdenum oxychloride composition comprises crystals and has a bulk density less than 0.75 g/cc. The process further comprises the step of separating the intermediate molybdenum oxychloride composition to form the molybdenum oxychloride composition. In this step, the bulk density of the intermediate molybdenum oxychloride powder is increased to achieve the aforementioned molybdenum oxychloride powder. In some cases, the larger crystals may be removed from the intermediate molybdenum oxychloride powder, e.g., via sieves or other size-related separation methods.

### EXAMPLES

The following examples are provided to illustrate the compositions and processes of the present disclosure. The examples are merely illustrative and are not intended to limit the disclosure to the materials, conditions, or process parameters set forth therein.

Molybdenum oxychloride powders of Examples 1 and 2 having smaller crystal size, e.g., less than 5 mm, e.g., approximately 0.8 mm to 2 mm, as described herein, were prepared. The powder was loaded into graduated glass containers of approximately 870 cc volume. Advantageously, due to minimal binder content (if any), no powder burn-out was performed. Conventional powders of Comparative Example A having larger crystal size was loaded into similar graduated glass containers. The loaded containers were weighed, and the bulk density was calculated accordingly. The results are shown in Table 1.

TABLE 1
Bulk Density

| | Amt. of Mo | | Calculated Bulk |
|---|---|---|---|
| | oxychloride, g | Volume, cc | Density g/cc |
| Ex. 1 | 1250 | 890 | 1.404 |
| Ex. 2 | 1250 | 850 | 1.471 |
| Comp. Ex. A | 750 | 890 | 0.843 |

As shown, the powders of Examples 1 and 2 demonstrate a significantly higher bulk density, e.g., greater than 1.4 g/cc. This high density beneficially allows for higher density consolidated masses, e.g., higher density powders. Advantageously, the higher density powders, contain more molybdenum oxychloride, and in use, the need to reload molybdenum oxychloride pellets in the semiconductor processing chambers may be significantly lessened.

Molybdenum oxychloride powders of Examples 3 and 4 having the smaller crystal sizes as described herein, were prepared and formed into tablets as shown in Table 2. Advantageously, due to minimal binder content (if any), no powder burn-out was performed. Conventional powders of Comparative Examples B and C having larger crystal sizes were similarly prepared and formed into tablets as shown in Table 2. Relative density was calculated by comparing tablet density with the maximum theoretical density of 3.31.

TABLE 2
Tablet Density

| | Tablet | Tablet | Tablet | Tablet |
|---|---|---|---|---|
| | Mass, g | Vol. cc | Den., g/cc | Rel. Den., % |
| Ex. 3 | ~1.2 | 0.4 | ~3.0 | 95+ |
| Ex. 4 | ~1.3 | 0.4 | ~3.25 | 97+ |
| Comp. Ex. B | 2.2 | 0.8 | 2.8 | 84.9 |
| Comp. Ex. C | 4.3 | 1.5 | 2.9 | 86.4 |

As shown in Table 2, the tablets of Examples 3 and 4 demonstrate much higher tablet densities and relative densities versus the conventional tablets of Comp Exs. B and C. Advantageously, the tablets of Examples 3 and 4 contain more molybdenum oxychloride, and in use, the need to reload molybdenum oxychloride pellets in the semiconductor processing chambers may be significantly lessened.

Molybdenum oxychloride powders of Examples 5-12 having the smaller crystal size as described herein, were prepared. The powders were measured for tap density, as measured by ASTM B527-2006. The conventional powder of Comparative Example D, with larger crystal size, was similarly measured for tap density. The results are shown in Table 3.

TABLE 3
Tap Density

| | Tap Density, g/cc |
|---|---|
| Ex. 5 | 1.01 |
| Ex. 6 | 1.02 |
| Ex. 7 | 0.98 |
| Ex. 8 | 1.02 |
| Ex. 9 | 1.04 |
| Ex. 10 | 0.91 |
| Ex. 11 | 1.01 |
| Ex. 12 | 1.07 |
| Comp. Ex. D | 0.80 |

As shown in Table 3, the tablets of Examples 5-12 demonstrate higher tap densities—well over 0.5 g/cc, e.g., over 0.80 g/cc. In fact, in most cases, the tap density was over 1.0 g/cc. As shown, Comp. Ex. D demonstrated a tap density of 0.80 g/cc which is 12% less than even the lowest working example (Ex. 10) ((0.91-0.8)→0.11/0.91=12%). Tap density for Comp. Ex. A was also less than those of Exs. 5-12. Beneficially, in use, the higher tap density powders disclosed provide for superior packing and require less compression than would be required for powders having lower tap density.

### Embodiments

The following embodiments, among others, are disclosed.

Embodiment 1: molybdenum oxychloride consolidated masses, comprising molybdenum oxychloride; and less than 10 wt % binder. The consolidated masses have a bulk density greater than 0.85, e.g., greater than 1.4 g/cc.

Embodiment 2: an embodiment of embodiment 1, wherein the molybdenum oxychloride comprises crystals, and wherein at least 90% of the crystals have an average cross body dimension less than 5 mm.

Embodiment 3: an embodiment of embodiment 1 or 2, wherein the consolidated masses comprise greater than 95 wt % molybdenum oxychloride.

Embodiment 4: an embodiment of any of embodiments 1-3, wherein the consolidated masses have a relative density greater than 75%.

Embodiment 5: an embodiment of any of embodiments 1-4, wherein the consolidated masses have a uniformity of heat transfer across the individual consolidated masses less than ±10%.

Embodiment 6: an embodiment of any of embodiments 1-5, wherein the molybdenum oxychloride comprises crystals, and wherein the crystals have a surface area greater than 0.0005 cm²/g.

Embodiment 7: an embodiment of any of embodiments 1-6, wherein the consolidated masses have an average cross body dimension greater than 1 mm.

Embodiment 8: an embodiment of any of embodiments 1-7, comprising less than 5 wt % of binder comprising ceramic binders, celluloses, or hydroxyalkyl celluloses, or mixtures thereof.

Embodiment 9: a molybdenum oxychloride composition comprising molybdenum oxychloride; and less than 10% binder. The molybdenum oxychloride composition has a bulk density greater than 0.75 g/cc.

Embodiment 10: an embodiment of embodiment 9, wherein the molybdenum oxychloride comprises crystals, and wherein at least 90% of the crystals have an average cross body dimension less than 1 mm.

Embodiment 11: an embodiment of embodiment 9 or 10, wherein the molybdenum oxychloride composition comprises greater than 95 wt % molybdenum oxychloride.

Embodiment 12: an embodiment of any of embodiments 9-11, wherein the molybdenum oxychloride composition has a tap density greater than 0.5 g/cc, e.g., greater than 1 g/cc, as measured by ASTM B527-2006.

Embodiment 13: an embodiment of any of embodiments 9-12, wherein the molybdenum oxychloride comprises crystals, and wherein the crystals have a surface area greater than 0.0005 cm²/g.

Embodiment 14: a process for producing molybdenum oxychloride consolidated masses, comprising providing a molybdenum oxychloride composition having a bulk density greater than 0.75 g/cc and comprising: molybdenum oxychloride; and less than 10% binder; and pressing the molybdenum oxychloride composition to form the consolidated masses. The consolidated masses have a bulk density greater than 1.4 g/cc.

Embodiment 15: an embodiment of embodiment 14, wherein the pressing comprises filling the molybdenum oxychloride composition into a mold and pressurizing the molded molybdenum oxychloride composition to form the consolidated masses.

Embodiment 16: an embodiment of embodiment 14 or 15, wherein the pressurizing is performed at a pressure less than 1000 MPa.

Embodiment 17: an embodiment of any of embodiments 14-16, wherein the providing comprises: synthesizing an intermediate molybdenum oxychloride composition comprising: molybdenum oxychloride; and less than 10% binder, wherein the intermediate molybdenum oxychloride composition comprises crystals and has a bulk density less than 0.75 g/cc; and separating the intermediate molybdenum oxychloride composition to form the molybdenum oxychloride composition.

While the invention has been described in detail, modifications within the spirit and scope of the invention will be readily apparent to those of skill in the art. In view of the foregoing discussion, relevant knowledge in the art and references discussed above in connection with the Background and Detailed Description, the disclosures of which are all incorporated herein by reference. In addition, it should be understood that aspects of the invention and portions of various embodiments and various features recited below and/or in the appended claims may be combined or interchanged either in whole or in part. In the foregoing descriptions of the various embodiments, those embodiments which refer to another embodiment may be appropriately combined with other embodiments as will be appreciated by one of skill in the art. Furthermore, those of ordinary skill in the art will appreciate that the foregoing description is by way of example only, and is not intended to limit.

1. Molybdenum oxychloride consolidated masses, comprising:
molybdenum oxychloride crystals; and
less than 10 wt % binder;
wherein the consolidated masses have a bulk density greater than 0.85 g/cc.

2. The consolidated masses of claim 1, wherein at least 90% of the crystals have an average cross body dimension less than 5 mm.

3. The consolidated masses of claim 1, wherein the consolidated masses comprise greater than 95 wt % molybdenum oxychloride crystals.

4. The consolidated masses of claim 1, wherein the consolidated masses have a relative density greater than 75%.

5. The consolidated masses of claim 1, wherein the consolidated masses have a uniformity of heat transfer across the individual consolidated masses less than ±10%.

6. The consolidated masses of claim 1, wherein the crystals have a surface area greater than 0.0005 cm²/g.

7. The consolidated masses of claim 1, wherein the consolidated masses have an average cross body dimension greater than 1 mm.

8. The consolidated masses of claim 1, comprising less than 5 wt % of binder comprising ceramic binders, celluloses, or hydroxyalkyl celluloses, or mixtures thereof.

9. A molybdenum oxychloride composition comprising:
molybdenum oxychloride crystals; and
less than 10% binder;
wherein the molybdenum oxychloride composition has a bulk density greater than 0.75 g/cc.

10. The composition of claim 9, wherein at least 90% of the crystals have an average cross body dimension less than 1 mm.

11. The composition of claim 9, wherein the molybdenum oxychloride composition comprises greater than 95 wt % molybdenum oxychloride crystals.

12. The composition of claim 9, wherein the molybdenum oxychloride composition has a tap density greater than 0.5 g/cc, as measured by ASTM B527-2006.

13. The composition of claim 9, wherein the molybdenum oxychloride comprises crystals, and wherein the crystals have a surface area greater than 0.0005 cm²/g.

14. A process for producing molybdenum oxychloride consolidated masses, comprising:
providing a molybdenum oxychloride composition having a bulk density greater than 0.75 g/cc and comprising:
molybdenum oxychloride crystals; and
less than 10% binder; and
pressing the molybdenum oxychloride composition to form the consolidated masses; wherein the consolidated masses have a bulk density greater than 1.4 g/cc.

15. The process of claim 14, wherein the pressing comprises:
filling the molybdenum oxychloride composition into a mold and
pressurizing the molded molybdenum oxychloride composition to form the consolidated masses.

16. The process of claim 15, wherein the pressurizing is performed at a pressure less than 1000 MPa.

17. The process of claim 14, wherein the providing comprises:
synthesizing an intermediate molybdenum oxychloride composition comprising:
molybdenum oxychloride crystals; and
less than 10% binder;
wherein the intermediate molybdenum oxychloride composition comprises crystals and has a bulk density less than 0.75 g/cc; and
separating the intermediate molybdenum oxychloride composition to form the molybdenum oxychloride composition.
